(19) United States
(12) Patent Application Publication
(10) Pub. No.: US 2007/0198995 A1
(43) Pub. Date: Aug. 23, 2007

(54) System and method for automated delivery of software

(76) Inventor: Richard Dellacona, Corona Del Mar, CA (US)

Correspondence Address: Don Carnegie;Suite 5A PMB540, 5405 Alton Parkway, Irvine, CA, 92604, US

(21) Appl. No.: 11/377,751

(22) Filed: Mar. 16, 2006

Related U.S. Application Data
(60) Provisional application No. 60/763,629, filed on Jan. 31, 2006.

(51) Int. Cl. G06F 9/46

(52) U.S. Cl. 719/321

(57) ABSTRACT

The present invention discloses system and method for delivery of software from a device to a host system, with the software enabling the host system to communicate with the device. The method of the present invention uses an electronic component/storage device associated with the device (or provides one if none exists), and configures the electronic component to comprise a file system and files that are native to operating system of the host, which the host system can recognize, access, and use automatically for initiating communications with the device.

### CROSS-REFERENCES TO RELATED APPLICATIONS

The present application claims the benefit of priority from related U.S. Provisional Patent Application Ser. No. 60/763,629, filed Jan. 31, 2006, the entire disclosure of which is incorporated herein by this reference.

### BACKGROUND OF THE INVENTION

(1) Field of the Invention

This invention relates to delivery of software and, more particularly, to automated delivery of software without user intervention.

(2) Description of Related Art

In general, software that a host system uses to communicate with a device (internal or external) are typically known as device driver (or driver programs or device software). Most devices using conventional peripheral interface that use standard protocols for data transfer require a device driver, which allows for communication of the device with an operating system that resides within the host system. Non-limiting examples of peripheral interface that use standard protocols for communication and data transfer may include any popular industry standard links or ports that use cables, Universal Serial Bus (USB), parallel, fire wire, network, optical, wireless, or a combination thereof, etc.

Conventional driver software delivery methods have been in use for a number of years. Reference is made to the following exemplary U.S. Pat. Nos. 6,754,722; 6,728,787; 6,668,376; 6,567,860; 6,513,159; 6,473,854; 5,752,032; 5,723,282; 5,555,401; and 5,319,751; and U.S. Patent Application Publications 2005/0257218; 2005/0160157; 2005/0132090; 2005/0038927; 2004/0019896; 2004/0230988; 2004/0187105; 2003/0046674; 2002/0174085; and 2002/0095526. Regrettably, most conventional driver software delivery methods suffer from obvious disadvantages in terms of generally involving end-users in the activation and or loading of the driver software.

The process of installing a driver software is typically performed by the user loading the driver software package (device driver plus a device driver installation program) into a computer system from a removable delivery media (e.g., an optical/magnetic media such as CD-ROM, flash, etc.), and launching a device driver installation program. The device driver installation program is usually launched by an executable setup file generally known as “setup.exe” that the operating system of the host retrieves and executes to commence the device driver installation program. The device driver installation program is generally comprised of Graphic User Interface (GUI) modules that aid the user in loading of the actual device driver. In other words, the device driver installation program generally includes GUI software with which the user interacts to update the various registers (settings or file systems) of the operating system to enable the host to communicate with the device. The use of removable delivery media for installing a driver software package requires shipping of the removable delivery media separately along with a device, which incurs additional cost. The cost of producing and shipping the driver software package can add to the overall cost of the device and, may in some cases, account for a significant fraction of the total cost for certain low cost devices, such as internal modems or scanners.

The driver software package may also be loaded and installed into a driver library of the operating system of the host computer, with the user manually selecting the driver software package from the driver library for launching the device driver installation program. However, this method of delivery provides a driver software package that is typically out-dated by the time it is installed. For example, the driver library in the operating system is the same age as the operating system. Hence, the driver software package in the driver library can potentially be many years old. Furthermore, if the device is new, a corresponding driver software package will not exist in the operating system's driver library.

Other delivery methods for installing driver software packages include the use of the network and the World Wide Web, which requires a user to have access to the Internet. This method of delivery requires user interaction with a device manufacturer website, which involves the process of downloading the driver software package therefrom, and the launch and interaction with the device driver installation program thereafter. In some instances, the host system is provided with a default driver that can act as an “interim” driver for the device in a restricted performance or mode until the user has access to the Internet and can download a current driver. However, this compounds the problem in that with the use of the Internet as a method for delivery of driver software, the manufacture of both a default driver as well as a current driver is required. In addition, with the default driver being shipped with the host system, within the host system driver library, the end users will encounter the same conventional problems mentioned above.

As is apparent from the prior art, conventional prior art installation processes and the medium of delivery for driver software are time-consuming and present a challenge for a novice computer user not familiar with the installation process. In addition, when the installation medium (e.g., CD, DVD, or other media, or access to the Internet) is needed in the future, and is unavailable, the device will not be able to communicate with the host system, and will be useless.

Regardless of the medium from which the device drivers are loaded within the host system, in most cases, the device driver packages include both the actual device driver and the device driver installation programs, which are supposed to aid the user in loading of the actual device driver. However, regrettably, the problem with most device driver installation programs is that (no matter how user friendly), they may interfere with an existing program, and may corrupt or disable the existing program, rendering it useless. Further, the interference of the device driver installation program with other programs may render the device useless. More costly problems for the manufacturers of a device driver software packages in relation to the device driver installation programs is that different versions (e.g., GUI interface, etc.) of the installation programs must be provided for different operating systems and/or different computing/communications devices. This often requires a manufacturer to ship a device with multiple versions of the device driver installation programs on removable delivery media or, alternatively, load the various versions within the driver libraries of the operating systems, or upload the versions onto network servers for retrieval and installation.

Accordingly, in light of the current state of the art and the drawbacks to current systems and methods for delivery of device software, a need exists for a system and a method for automatic delivery for software without user intervention or complex installation programs, and wherein the software and the device to which the software belongs are paired.

### BRIEF SUMMARY OF THE INVENTION

The present invention discloses system and method for delivery of software from a device to a host system, with the software enabling the host system to communicate with the device. The method and system of the present invention uses an electronic component associated with the device (or provides one if none exists), and configures the electronic component to comprise a file system and files that are native to operating system of the host, which the host system can recognize, access, and use automatically for initiating communications with the device.

One aspect of the present invention provides a system and a method for delivery of software from a device to a host system, with the software enabling the host system to communicate with the device, comprising the acts of:
using an electronic component associated with the device;
configuring the electronic component to comprise a file system that is native to operating systems, which the host system can recognize, access, and use automatically for initiating communications with the device;
providing a primary file within the file system, with the primary file containing information that enables the host system for automatically taking action upon connection of the device with the host system; and
providing a secondary file pointed to by the primary file, with the secondary file having a set of executable commands that are executed by the host system for delivery of software from the electronic component associated with the device to the host system.

An optional aspect of the present invention provides a system and a method for delivery of software from a device to a host system, with the software enabling the host system to communicate with the device, wherein:
the electronic component is a memory in the device.

Another optional aspect of the present invention provides a system and a method for delivery of software from a device to a host system, with the software enabling the host system to communicate with the device, wherein:

wherein:

the memory is formatted to the file system that is recognized by the host system.

Still another optional aspect of the present invention provides a system and a method for delivery of software from a device to a host system, with the software enabling the host system to communicate with the device, wherein:
the electronic component is a programmed chip of the device comprising the file system.

Yet another optional aspect of the present invention provides a system and a method for delivery of software from a device to a host system, with the software enabling the host system to communicate with the device, wherein:
the electronic component is a fixed storage unit of the device.

Further optional aspect of the present invention provides a system and a method for delivery of software from a device to a host system, with the software enabling the host system to communicate with the device, wherein:
the fixed storage unit is formatted to the file system that is recognized by the host system.

Still a further optional aspect of the present invention provides a system and a method for delivery of software from a device to a host system, with the software enabling the host system to communicate with the device, wherein:

wherein:

the file system is configured as a read only memory, containing a self-executing file.

Another optional aspect of the present invention provides a system and a method for delivery of software from a device to a host system, with the software enabling the host system to communicate with the device, wherein:
the file system is a CD File System Read-Only-Memory.

Yet another optional aspect of the present invention provides a system and a method for delivery of software from a device to a host system, with the software enabling the host system to communicate with the device, wherein:
the primary file, generally a “autorun.inf” file, points to the software that is delivered to the host system.

A further optional aspect of the present invention provides a system and a method for delivery of software from a device to a host system, with the software enabling the host system to communicate with the device, wherein:
the secondary file is comprised of a series of commands that are executed in sequence, and which are grouped as a batch within the secondary file.

Still a further optional aspect of the present invention provides a system and a method for delivery of software from a device to a host system, with the software enabling the host system to communicate with the device, wherein:
a connection between the device and the host system is through a peripheral interface using standard protocols for data transfer.

Another optional aspect of the present invention provides a system and a method for delivery of software from a device to a host system, with the software enabling the host system to communicate with the device, wherein:
the peripheral interface is a link, using the standard protocols for data transfer.

Yet anther optional aspect of the present invention provides a system and a method for delivery of software from a device to a host system, with the software enabling the host system to communicate with the device, wherein:
the software is used by the host system for communicating with the device, and includes a set of commands that are executed for settings that are needed for the host system to recognize the device.

Another aspect of the present invention provides a system and a method for delivery of software that is used for allowing a host system to recognize a device, with the software enabling the host system to communicate with the device, comprising the acts of:
coupling the device with the host system, with the host system:
detecting the presence of the device;
determining the existence of a software within the host system;
if it is determined that the software does not exists within the host system:
   accessing an electronic component of the device;
   recognizing and reading a file system within the electronic component;
   retrieving the software from the electronic component by executing a primary file system within the electronic component that includes the software; and
   installing software.

Another aspect of the present invention provides a system for delivery of software from a device to a host system, with the software enabling the host system to communicate with the device, comprising:
the device having an electronic component that is configured to comprise a file system that is native to the operating system of the host system, which the host system can recognize, access, and use automatically for initiating communications with the device;
the electronic component comprising a primary file within the file system, with the primary file containing information that enables the host system for automatically taking appropriate action upon connection of the device with the host system; and
the primary file pointing to a secondary file, with the secondary file having a set of executable commands that are executed by the host system for delivery of software from the electronic component of the device to the host system.

Another aspect of the present invention provides a system for delivery of software from a device to a host system for allowing the host system to recognize and communicate with the device, comprising:
the device having an electronic component that is configured to comprise a file system that is native to the operating system of the host system, which the host system can recognize, access, and use automatically for initiating communications with the device;
the electronic component comprising a primary file within the file system, with the primary file containing information that enables the host system for automatically taking appropriate action upon connection of the device with the host system; and
the primary file pointing to a secondary file, with the secondary file having a set of executable commands that are executed by the host system for delivery of the software from the electronic component of the device to the host system;
the device coupled with the host system, with the host system detecting the presence of the device, and determining the existence of the software within the host system;
   if it is determined that the software does not exist within the host system, the host system accessing the electronic component of the device, and reading the file system within the electronic component for retrieving the software from the electronic component by executing the primary file system containing the software for installing the software.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary block diagram depicting the components of a host system and a device, which are linked together via a linkage, using standard protocols for data transfer in accordance with the present invention;

FIG. 2 is an exemplary flowchart diagram for a method of enabling device of FIG. 1 to be recognized, accessed, and used by the host system of FIG. 1 in accordance with the present invention; and

FIG. 3 is an exemplary flowchart showing the method of delivery of software from the device of FIG. 1 to the host system of FIG. 1, when the host system is in communication with the device in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers.

This disclosure refers throughout to the terms “driver,” “device drivers,” “driver software,” “device driver software,” or the like, which the present invention defines as software or software programs that a host system uses to communicate with a device (internal or external). In particular, a driver is generally defined as software that includes a set of commands (program instructions) executed for settings that are needed for the host system to recognize and communicate with a device. It should be noted that a device driver is not a device driver installation program.

Further, and for the sake of convenience and clarity, this disclosure refers throughout to the term device (or periphery device or source system), the non-limiting examples of which may include a piece of hardware (e.g., printer, modem, etc.) that may reside internal or external of the host system (or destination system). Non-limiting examples of host systems (which themselves may be a device to other host or destination systems) may include a Personal Computer (PC), handheld devices such as Personal Digital Assistance (PDA), communication units such as cellular telephone, etc.

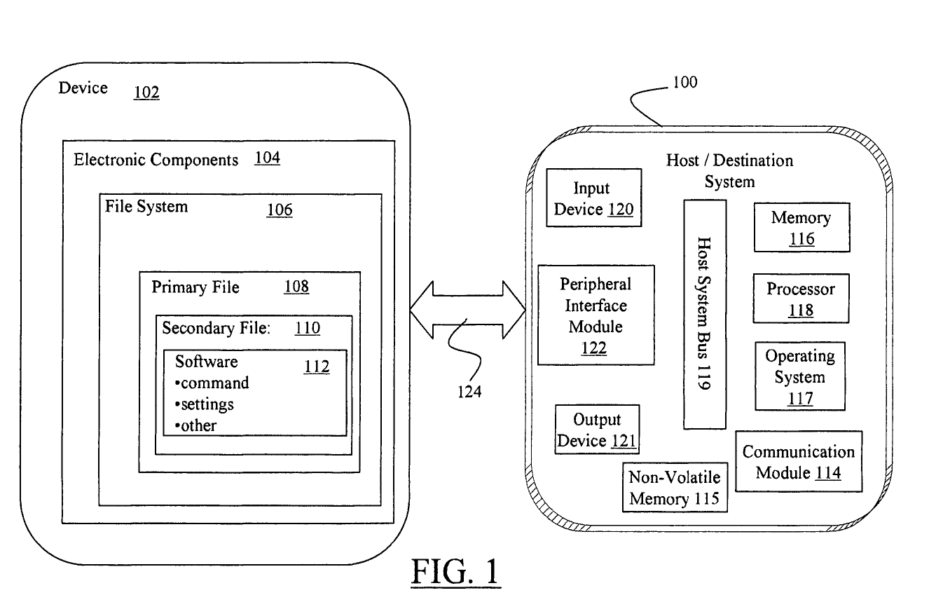

As best illustrated in FIG. 1, the present invention provides an automated deliver of software 112 from a device 102 to a host system 100. FIG. 1 is an exemplary block diagram depicting the components of the host system 100 and the device 102, which are linked together via a linkage 124, using standard protocols for data transfer. In generally, the host system 100 is comprised of a processor 118 that is in communication via bus 119 with the various modules and components within the host system 100, in accordance with protocols of an operating system 117. In general, the operating system 117 resides on a non-volatile storage device 115, which may also include the BIOS that resides on a non-volatile memory device. The processor 118 may be a general-purpose computer processor or a specialized processor such as an Application Specific Integrated Circuit (ASIC).

As illustrated, the host system 100 is comprised of a peripheral interface module 122 configured for receiving user input from an input device 120 such as a keyboard, a mouse, or any other device 102 (internal or external). The peripheral interface module 122, may include multiple “ports” for receiving and transmitting data and user input/output, and may also be configured to receive and transmit information from and or to other remote devices using wired or wireless connections via a communication module 114. In addition, the peripheral interface module 122 is further configured for outputting of information to the user, possibly through an output device 121 via an exemplary video display. The data or information from the peripheral interface module 122 may also be provided to other devices 102 (internal or external) or other programs, e.g., to other software modules, for use therein, possibly serving as a wired or wireless gateway to external databases or other processing devices or communications nodes. As further illustrated in FIG. 1, the processor 118 is also in communication via bus 119 with a memory 116 to permit storage of data and software to be manipulated by commands to the processor 118, and with a communication module 114, which can be comprised of any well-known transceiver module, internal modem, or the like.

The linkage 124 between the peripheral interface module 122 and other devices 102 (internal or external) may be accomplished by any well-known standard protocol for data transfer. Non-limiting examples of peripheral interface modules 122 that use standard protocols for communication and data transfer may include any popular industry standard links or ports that use cables, Universal Serial Bus (USB), parallel, fire wire, network, optical, wireless, or a combination thereof, etc.

The exemplary device 102 illustrated in FIG. 1 is comprised of any periphery device or source system, which may be internal or external to the host system 100, and generally includes one or more electronic components 104. In order to enable delivery of software (e.g., a device driver) 112 from the device 102 to the host system 100, the device 102 must either already include or be provided with the electronic component 104 that is capable of storing software 112, and that the host system 100 must recognize, access, and use the electronic component 104 to access the software 112 for retrieval. Therefore, in one embodiment, the electronic component 104 (already included or being provided) is comprised of a memory and or a fixed storage unit of the device 102, which may be formatted to a file system or directory 106 that the operating system 117 of the host system 100 recognizes. The file system or directory 106 includes at least one primary file 108, a secondary file 110, and the software 112. In an alternative embodiment, the electronic component 104 is comprised of a programmed chip of the device 102 that includes the file system or directory 106 that is recognized by the operating system 117, including the primary file 108, the secondary file 110, and software 112.

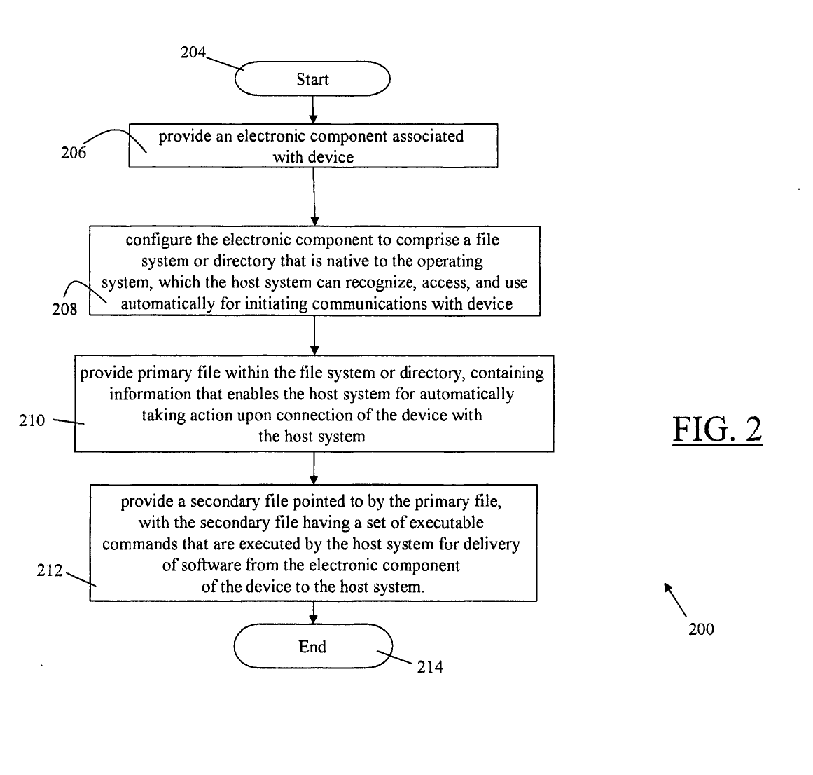

FIG. 2 is an exemplary flowchart diagram for a method of enabling the electronic component 104 of the device 102 to be recognized, accessed, and used by the host system 100. With the enabling method illustrated in FIG. 2, and described below, the software (e.g., a device driver) 112 is installed onto the host system 100 from the device 102, without a setup file (e.g., setup.exe), user intervention, or device driver installation programs.

As illustrated in FIGS. 1 and 2, for delivery of software 112 from the device 102 to the host system 100, in operation 206, the electronic component 104 of the device 102 is used by the present invention to store the software 112 (e.g., a device driver) therein. This would eliminate the need to store the software 112 on a removable delivery media, or store it within the driver library of an operating system or use the Internet to store software 112. In other words, the device 102 and its exemplary driver software 112 are paired.

As further illustrated FIG. 2, in operation 208, the electronic component 104 is configured to comprise a file system or directory 106 that is native to the operating system 117 of the host system 100. Therefore, the host system 100 is able to recognize, access, and use the electronic component 104 for automatically initiating communications with the device 102. If the electronic component 104 is a memory or a fixed storage unit, the configuration process entails the well-known method of formatting the electronic component 104 so that the operating system 117 of the host system 100 can recognize, access (read), and use (execute) files within the file system or directory 106. If the electronic component 104 is a programmed chip, the programming of the chip should result in a file system or directory 106 that is recognized, accessed (read), and used (executed) by the operating system 117. In one embodiment, the file system 106 is configured as a read only memory, containing a self-executing file such as the primary file 108. A non-limiting example for the file system 106 with a read only memory file system is a CD File System Read-Only-Memory, which is recognized by most of today's operating systems.

As further illustrated, in the operation 210, the electronic component 104 is further provided with a primary file 108 within the file system or directory 106, with the primary file 108 containing information that enables the host system 100 for automatically taking appropriate action upon connection of the device 102 with the host system 100. At operation 212, the primary file 108 is made to generally include or point to a secondary file 110, with the secondary file 110 having a set of executable commands that are executed by the host system 100 for delivery of software 112 from the electronic component 104 of the device 102 to the host system 100.

As stated above, most of today's operating systems use a removable delivery media (such as an optical media for example a CD) for recognizing and loading device drivers via a USB connection. In general, the file system or directory 106 in combination with the primary file 108 are configured for signaling the operating system 117 of the host system 100 that the medium (the electronic component 104), which the software 112 reside on and is to be delivered from is an “automated run media.” A non-limiting example of an automated run media is an autorun.INF file found on most of today's removable delivery media, which are easily recognized by most operating systems. The method of FIG. 2 of the present invention enables today's operating systems to view (or perceive) the electronic component 104 as a “removable delivery media.” Hence, the automated run file within the file system 106 generally contains information that enables the operating system 117 of the host system 100 to automatically initiate appropriate action, immediately upon connection of the device 102 with the host system 100. In one embodiment, the primary file 108 includes at least partial information related to one or more contents of an INF file, which is recognized and accessed by most of today's operating systems.

The secondary file 110 is pointed to by the primary file 108, with the secondary file 110 having one or more executable commands that are executed by the host system 100 for delivery of software 112 from the electronic component 104 associated with the device 102 to the host system 100. In general, the secondary file 110 is comprised of one or more commands that are executed in sequence, and which are grouped as a batch within the secondary file 110. These commands, along with appropriate protocols of the operating system 117, enable loading of the software 112 from the device 102 to the host system 100. The commands found in the secondary file may be as simple as a copy command that when executed by the operating system 117, copies all the files or the entire software 112 from the device 102 to the host system 100, and the operating system 117 then updates the various registers (settings or file systems) of the host system 100.

It should be noted that with the delivery method of the present invention illustrated and described, there is no device driver installation program (the setup files GUI that the users use to interact with the device 102) to update the various registers (settings or file systems) of the operating system 117 to enable the host 100 to communicate with the device 102. The software 112 is installed onto the host system 100 from the device 102, without a setup file, user intervention, or device driver installation programs, and the registry (settings or file systems) of the operating system is updated automatically in accordance with the software 112 and the operating system 117 protocols.

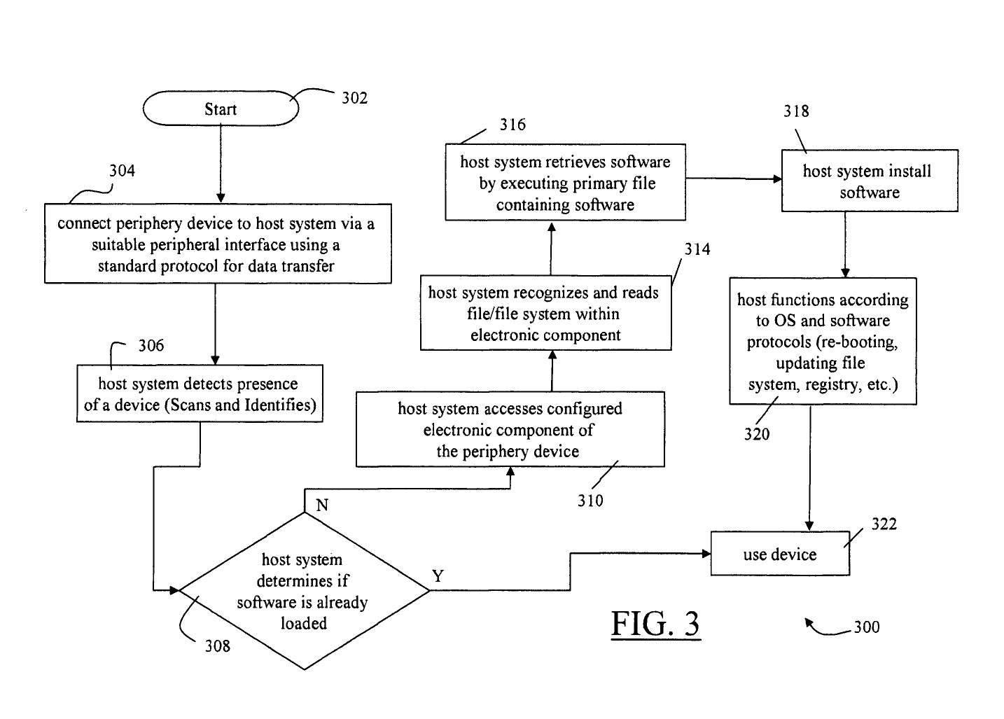

FIG. 3 is an exemplary flowchart showing the method of delivery of software from a device 102 to a host system 100, when the host system 100 is in communication 124 with the device 102. As illustrated in FIGS. 1, and 3, at operation 304, the periphery device 102 is coupled with the host system 100 via a suitable peripheral interface 122 using a standard protocol for data transfer, a non-limiting example of which is a USB connection. After the connection, at operation 306, the host system 100 detects and identifies the presence of the device 102 by well-known methods such as scanning and Identifying. At operation 308, host system 100 determines if software 112 is already loaded within the host system 100. If it is determined that the software 112 exists, at operation 322, the host system 100 communicates with the device 102 using the software 112 within the host system 100. Otherwise, if it is determined that the software 112 is not loaded within the host system 100, at operation 310, the host system 100 accesses configured electronic component 104 of the periphery device 102 for retrieval of the software 112. At operation 314, the operating system 117 of the host system 100 recognizes the file system 106 (non-limiting example, a CD File System), and reads and executes the primary file 108 (non-limiting example, autorun.INF) within electronic component 104. At operation 316, host system 100 retrieves software 112 by executing the primary file 108, which points to a secondary file 110 (non-limiting example, a “*.batch” file), which simply enables the host system 100 to retrieve the software 112. At operation 318, the host system 100 executes the secondary file 110 and installs the software 112 according to the software 112 protocols, and at operation 320, the host system 100 functions according to the operating system 117 and the software 112 protocols (e.g., updating the registers, updating files systems, re-booting, etc.). It should be noted that the software 112 is used by the host system 100 for communicating with the device 102, and includes a set of commands that are executed for settings that are needed for the host system 100 to recognize and communicate the device 102.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A method for delivery of software from a device to a host system, with the software enabling the host system to communicate with the device, comprising the acts of:
using an electronic component associated with the device;
configuring the electronic component to comprise a file system that is native to operating systems, which the host system can recognize, access, and use automatically for initiating communications with the device;
providing a primary file within the file system, with the primary file containing information that enables the host system for automatically taking action upon connection of the device with the host system; and
providing a secondary file pointed to by the primary file, with the secondary file having a set of executable commands that are executed by the host system for delivery of software from the electronic component associated with the device to the host system.

2. A method for delivery of software from a device to a host system, with the software enabling the host system to communicate with the device, as set forth in claim 1, wherein:
the electronic component is a memory of the device.

3. A method for delivery of software from a device to a host system, with the software enabling the host system to communicate with the device, as set forth in claim 2, wherein:
the storage device is formatted to the file system that is recognized by the host system.

4. A method for delivery of software from a device to a host system, with the software enabling the host system to communicate with the device, as set forth in claim 1, wherein:
the electronic component is a storage device comprising the file system.

5. A method for delivery of software from a device to a host system, with the software enabling the host system to communicate with the device, as set forth in claim 1, wherein:
the electronic component is a fixed storage unit of the device.

6. A method for delivery of software from a device to a host system, with the software enabling the host system to communicate with the device, as set forth in claim 5, wherein:
the fixed storage unit is formatted to the file system that is recognized by the host system.

7. A method for delivery of software from a device to a host system, with the software enabling the host system to communicate with the device, as set forth in claim 1, wherein:
the file system is configured as a read only memory, containing a self-executing file.

8. A method for delivery of software from a device to a host system, with the software enabling the host system to communicate with the device, as set forth in claim 1, wherein:
the file system is a CD File System Read-Only-Memory.

9. A method for delivery of software from a device to a host system, with the software enabling the host system to communicate with the device, as set forth in claim 1, wherein:
the primary file includes at least partial information related to one or more contents of an INF file, accessed by the host system.

10. A method for delivery of software from a device to a host system, with the software enabling the host system to communicate with the device, as set forth in claim 1, wherein:
the secondary file is comprised of a series of commands that are executed in sequence, and which are grouped as a batch within the secondary file.

11. A method for delivery of software from a device to a host system, with the software enabling the host system to communicate with the device, as set forth in claim 1, wherein:
a connection between the device and the host system is through a peripheral interface using standard protocols for data transfer.

12. A method for delivery of software from a device to a host system, with the software enabling the host system to communicate with the device, as set forth in claim 11, wherein:
the peripheral interface is a link, using the standard protocols for data transfer.

13. A method for delivery of software from a device to a host system, with the software enabling the host system to communicate with the device, as set forth in claim 1, wherein:
the software is used by the host system for communicating with the device, and includes a set of commands that are executed for settings that are needed for the host system to recognize the device.

14. A method for delivery of software that is used for allowing a host system to recognize a device, with the software enabling the host system to communicate with the device, comprising the acts of:
coupling the device with the host system, with the host system:
detecting the presence of the device;
determining the existence of a software within the host system;
if it is determined that the software does not exists within the host system:
accessing an electronic component of the device;
recognizing and reading a file system within the electronic component;
retrieving the software from the electronic component by executing a primary file system within the electronic component that includes the software; and
installing software.

15. A method for delivery of software that is used for allowing a host system to recognize a device, with the software enabling the host system to communicate with the device, as set forth in claim 14, wherein:
the electronic component is a memory of the device.

16. A method for delivery of software that is used for allowing a host system to recognize a device, with the software enabling the host system to communicate with the device, as set forth in claim 15, wherein:
the memory is formatted to the file system that is recognized by the host system.

17. A method for delivery of software that is used for allowing a host system to recognize a device, with the software enabling the host system to communicate with the device, as set forth in claim 14, wherein:
the electronic component is a programmed chip of the device comprising the file system.

18. A method for delivery of software that is used for allowing a host system to recognize a device, with the software enabling the host system to communicate with the device, as set forth in claim 14, wherein:
the electronic component is a fixed storage unit of the device.

19. A method for delivery of software that is used for allowing a host system to recognize a device, with the software enabling the host system to communicate with the device, as set forth in claim 18, wherein:
the fixed storage unit is formatted to the file system that is recognized by the host system.

20. A method for delivery of software that is used for allowing a host system to recognize a device, with the software enabling the host system to communicate with the device, as set forth in claim 14, wherein:
the file system is configured as a read only memory, containing a self-executing file.

21. A method for delivery of software that is used for allowing a host system to recognize a device, with the software enabling the host system to communicate with the device, as set forth in claim 14, wherein:
the file system is a CD File System Read-Only-Memory.

22. A method for delivery of software that is used for allowing a host system to recognize a device, with the software enabling the host system to communicate with the device, as set forth in claim 14, wherein:
the primary file includes at least partial information related to one or more contents of an INF file, accessed by the host system.

23. A method for delivery of software that is used for allowing a host system to recognize a device, with the software enabling the host system to communicate with the device, as set forth in claim 14, wherein:
a secondary file is pointed to by the primary file, the secondary file is comprised of a series of commands that are executed by the host system in sequence, and which are grouped as a batch within the secondary file.

24. A method for delivery of software that is used for allowing a host system to recognize a device, with the software enabling the host system to communicate with the device, as set forth in claim 14, wherein:
the act of coupling is comprised of a connection between the device and the host system is through a peripheral interface using standard protocols for data transfer.

25. A method for delivery of software that is used for allowing a host system to recognize a device, with the software enabling the host system to communicate with the device, as set forth in claim 24, wherein:
the peripheral interface is a link, using the standard protocols for data transfer.

26. A method for delivery of software that is used for allowing a host system to recognize a device, with the software enabling the host system to communicate with the device, as set forth in claim 14, wherein:
the software is used by the host system for communicating with the device, and includes a set of commands that are executed for settings that are needed for the host system to recognize the device.

27. A system for delivery of software from a device to a host system, with the software enabling the host system to communicate with the device, comprising:
the device having an electronic component that is configured to comprise a file system that is native to the operating system of the host system, which the host system can recognize, access, and use automatically for initiating communications with the device;
the electronic component comprising a primary file within the file system, with the primary file containing information that enables the host system for automatically taking appropriate action upon connection of the device with the host system; and
the primary file pointing to a secondary file, with the secondary file having a set of executable commands that are executed by the host system for delivery of software from the electronic component of the device to the host system.

28. A system for delivery of software from a device to a host system, with the software enabling the host system to communicate with the device, as forth in claim 27, wherein:
the electronic component is a memory of the device.

29. A system for delivery of software from a device to a host system, with the software enabling the host system to communicate with the device, as forth in claim 28, wherein:
the storage device is formatted to the file system that is recognized by the host system.

30. A system for delivery of software from a device to a host system, with the software enabling the host system to communicate with the device, as forth in claim 27, wherein:
the electronic component is a memory chip of the device comprising the file system.

31. A system for delivery of software from a device to a host system, with the software enabling the host system to communicate with the device, as forth in claim 24, wherein:
the electronic component is a fixed storage unit of the device.

32. A system for delivery of software from a device to a host system, with the software enabling the host system to communicate with the device, as forth in claim 31, wherein:
the fixed storage unit is formatted to the file system that is recognized by the host system.

33. A system for delivery of software from a device to a host system, with the software enabling the host system to communicate with the device, as forth in claim 27, wherein:
the file system is configured as a read only memory, containing a self-executing file.

34. A system for delivery of software from a device to a host system, with the software enabling the host system to communicate with the device, as forth in claim 27, wherein:
the file system is a CD File System Read-Only-Memory.

35. A system for delivery of software from a device to a host system, with the software enabling the host system to communicate with the device, as forth in claim 27, wherein:
the primary file is the autorun.inf file that includes at least partial information related to one or more contents files.

36. A system for delivery of software from a device to a host system, with the software enabling the host system to communicate with the device, as forth in claim 27, wherein:
the secondary file is comprised of a series of commands that are executed in sequence, and which are grouped as a batch within the secondary file.

37. A system for delivery of software from a device to a host system, with the software enabling the host system to communicate with the device, as forth in claim 27, wherein:
the connection between the device and the host system is through a peripheral interface using standard protocols for data transfer.

38. A system for delivery of software from a device to a host system, with the software enabling the host system to communicate with the device, as forth in claim 37, wherein:
the peripheral interface is a link, using the standard protocols for data transfer.

39. A system for delivery of software from a device to a host system, with the software enabling the host system to communicate with the device, as forth in claim 27, wherein:
the software is used by the host system for communicating with the device, and includes a set of commands that are executed for settings that are needed for the host system to recognize the device.

40. A system for delivery of software from a device to a host system for allowing the host system to recognize and communicate with the device, comprising:
the device having an electronic component that is configured to comprise a file system that is native to the operating system of the host system, which the host system can recognize, access, and use automatically for initiating communications with the device;
the electronic component comprising a primary file within the file system, with the primary file containing information that enables the host system for automatically taking appropriate action upon connection of the device with the host system; and
the primary file pointing to a secondary file, with the secondary file having a set of executable commands that are executed by the host system for delivery of the software from the electronic component of the device to the host system;
the device coupled with the host system, with the host system detecting the presence of the device, and determining the existence of the software within the host system;
if it is determined that the software does not exist within the host system, the host system accessing the electronic component of the device, and reading the file system within the electronic component for retrieving the software from the electronic component by executing the primary file system containing the software for installing the software.

41. A system for delivery of software from a device to a host system for allowing the host system to recognize and communicate with the device as forth in claim 40, wherein:
the electronic component is a memory of the device.

42. A system for delivery of software from a device to a host system for allowing the host system to recognize and communicate with the device as forth in claim 41, wherein:
the memory is formatted to the file system that is recognized by the host system.

43. A system for delivery of software from a device to a host system for allowing the host system to recognize and communicate with the device as forth in claim 40, wherein:
the electronic component is a storage chip of the device comprising the file system.

44. A system for delivery of software from a device to a host system for allowing the host system to recognize and communicate with the device as forth in claim 40, wherein:
the electronic component is a fixed storage unit of the device.

45. A system for delivery of software from a device to a host system for allowing the host system to recognize and communicate with the device as forth in claim 44, wherein:
the fixed storage unit is formatted to the file system that is recognized by the host system.

46. A system for delivery of software from a device to a host system for allowing the host system to recognize and communicate with the device as forth in claim 40, wherein:
the file system is configured as a read only memory, containing a self-executing file.

47. A system for delivery of software from a device to a host system for allowing the host system to recognize and communicate with the device as forth in claim 40, wherein:
the file system is a CD File System Read-Only-Memory.

48. A system for delivery of software from a device to a host system for allowing the host system to recognize and communicate with the device as forth in claim 40, wherein:
the primary file is an autorun.inf and points to one or more files.

49. A system for delivery of software from a device to a host system for allowing the host system to recognize and communicate with the device as forth in claim 40, wherein:
the secondary file is comprised of a series of commands that are executed in sequence, and which are grouped as a batch within the secondary file.

50. A system for delivery of software from a device to a host system for allowing the host system to recognize and communicate with the device as forth in claim 40, wherein:
the connection between the device and the host system is through a peripheral interface using standard protocols for data transfer.

51. A system for delivery of software from a device to a host system for allowing the host system to recognize and communicate with the device as forth in claim 40, wherein:
the peripheral interface is a link, using the standard protocols for data transfer.

52. A system for delivery of software from a device to a host system for allowing the host system to recognize and communicate with the device as forth in claim 40, wherein:
the software is used by the host system for communicating with the device, and includes a set of commands that are executed for settings that are needed for the host system to recognize the device.
